(19) United States
(12) Patent Application Publication
(10) Pub. No.: US 2009/0106546 A1
(43) Pub. Date: Apr. 23, 2009

(54) Method and Software System for Configuring a Modular System

(76) Inventors: Bernhard Weichel, Stuttgart (DE); Frank Neukam, Korntal (DE)

Correspondence Address: KENYON & KENYON LLP, ONE BROADWAY, NEW YORK, NY, 10004, US

(21) Appl. No.: 11/988,846

(22) PCT Filed: Jun. 30, 2006
(86) PCT No.: PCT/EP2006/063765

§ 371 Date: Jan. 14, 2008

(30) Foreign Application Priority Data
Jul. 14, 2005 (DE) 10 2005 032 944.6

(51) Int. Cl. G06F 9/00

(52) U.S. Cl. 713/100

(57) ABSTRACT

In order particularly easily and flexibly to configure a system including at least one module, a method has the following steps: creation of at least one implementation-independent configuration data file and/or modification of information stored in the at least one implementation-independent configuration data file; automatic setup and/or automatic update of configuration data, stored in a configuration data container, as a function of the information stored in the at least one implementation-independent configuration data file; automatic configuration of at least one module as a function of the stored in the configuration data container.

### FIELD OF THE INVENTION

The present invention relates to a method and a software system for configuring a system including at least one module (a modular system).

### BACKGROUND INFORMATION

By systems including at least one module (modular systems), particularly microprocessor programs are to be understood, of the type described below. In this case, a module can be equated to a functional unit. The method is, however, not restricted to microprocessor programs, but can be used generally for configuring modular systems in which individual modules are configured and assembled.

Microprocessors are used these days in all important technological fields. Their use is not limited to the usual personal computers (PC's), in this context, but rather extends beyond this to many different electronic devices, such as measuring devices, control devices, etc., particularly in the automotive industry.

Modern microprocessor programs and computer programs are predominantly programmed in such a way that they are useable in as broad a range of application as possible. The range of application is determined, on one hand, by the functionalities made available, which in turn should cover as many desires of the user as possible, and, on the other hand, by the underlying hardware on which the microprocessor program is to run. In this context, the underlying hardware denotes different (computer) systems which are used in different areas, are constructed of different components (e.g., processors or bus systems), and/or have different peripheral devices.

Different functionalities can result from different conditions of the underlying hardware or from different user desires. Adaptation, and therefore specialization, of a microprocessor program to an underlying hardware and to specific user desires includes a so-called configuration of the microprocessor program.

For example, a configuration includes the activation or deactivation of individual functions of the microprocessor program, the setting of starting values for certain variables or the preselecting and specifying of certain variable types.

It is well-known that one may declare the variables and functions used in a microprocessor program in a so-called header file, and that one may configure the microprocessor program by changing individual variables or function designators in the header file. For example, it is possible to assign a special function to a function designator used in the microprocessor program and declared in the header file, as a function of a specific configuration.

Microprocessor programs are usually created in a so-called high-level programming language, e.g., C, C++, Scheme or JAVA. A microprocessor program created in a high-level programming language is usually referred to as source code. To permit execution of such a microprocessor program on a microprocessor, a so-called machine code must be generated from the source code, the machine code containing instructions which are executable by the processor. Machine code can be generated by so-called interpretation or compilation of the source code.

Typically, a microprocessor program includes a plurality of functional units. The source code of one or more functional units is stored in a data file, in this instance. A header file is assigned to one or more such data files. Thus, a microprocessor program is typically made up of a plurality of data files. A configuration of such a microprocessor program, which is accomplished by changes within individual header files, is therefore very unclear and can often only be accomplished by the creator of the source code. In addition, a documentation must be created for all header files, which is very painstaking; even the documentation for the most part being very unclear.

To configure a microprocessor program, it is also known to assign it a special functional unit by which it is possible to configure the entire microcomputer program, for instance, by modifying the values of predefined parameters. For example, the functional unit may be launched from within the microprocessor program running, and be executed for configuring the microprocessor program. However, such a functional unit provided for configuring the microprocessor program only allows a configuration within predefined range limits. A configuration of the microprocessor program, e.g., for adapting the computer program to new hardware or for adapting the microprocessor program to new desires of the user is not possible using such a functional unit. Moreover, the functional unit used for the configuration must be developed specially for the microprocessor program in question, and cannot be used for other microprocessor programs.

German Published Patent Application No. 10 2004 005 730 describes that the configuration of a microprocessor program is improved, and a resource-optimized implementation is achieved, by providing, between a user (configurator) and the microprocessor program, an abstract description of the configuration to be executed in an implementation-independent configuration data file, which is made the basis for the configuration. With the aid of the implementation-independent configuration data file, an implementation-dependent configuration data file is automatically created which is then utilized for configuring the microprocessor program. In order to ensure that the configuration process, and eventually the microprocessor program, is error-free, multiple checking processes are carried out during the creation of the implementation-dependent configuration data files. The creation and attachment of these checking processes is difficult and costly, particularly since they are generated and programmed in program code.

### SUMMARY

Thus, example embodiments of the present invention simplify the configuration of microprocessor programs, and design them as clearly as possible and as flexibly as possible.

The data determining a configuration are stored independently of an intended, specific implementation, in one or more implementation-independent configuration data files. The implementation independence of this configuration data file permits, in particular, an abstract description of the stored information. This makes it possible to store the information relevant for the configuration of the microprocessor program so that it can be read particularly well, and therefore to markedly simplify the configuration. Because this configuration data file is implementation-independent, it is possible in particular to configure the microprocessor program in a simple manner so that, for instance, the microprocessor program is executable on a new computer system whose exact parameters were not even known yet when the computer program was created.

The configuration data container makes it possible to centrally provide all data relevant for a configuration.

The at least one module is configured automatically with the aid of the configuration data stored in the configuration data container.

According to an example embodiment of the method according to the present invention, it is provided that, using the configuration data filed in the configuration data container, automatically at least one implementation-dependent configuration data file is created, the automatic configuration of the at least one module being carried out as a function of the information stored in the at least one implementation-dependent configuration data file.

In each of the example embodiments of this step, a specification takes place of individual or several parameter values with regard to the implementation-independent configuration data file. In such a concretization, for example, relative values are replaced by absolute values. Specific data types or structures may be assigned to individual values or data areas, as well.

The implementation-dependent configuration data file takes into account implementation-dependent properties, such as one or more programming languages used when programming the source code, or properties of the hardware on which the microprocessor program is intended to run.

The setup or the updating of the configuration data container with the aid of the information stored in the implementation-independent configuration data files may be carried out using so-called scripts, for example. In this context, a script denotes a sequence of instructions which are executable by a special microprocessor program. Such special microprocessor programs are AWK or Perl, for example. These special microprocessor programs may also be used for creating implementation-dependent configuration data files, or the configuration of the module, from the configuration data stored in the configuration data container.

Moreover, configuration rules are used in the method. In this context, one or more configuration rules are assigned to each configuration parameter. In the configuration rules it can be stipulated, for example, which data sources or groups of data sources for a certain configuration parameter are valid, necessary or prohibited. In using the method for complex software systems, one should understand by the term data sources especially the components of this software system, for instance, configuration data. In the motor vehicle field, possible data sources for configuration data are, for instance, lambda regulation, accelerator preparation, diagnosis system, etc. In citing the valid data sources, quantifying specifications such as “all sources without difference” or “component X with the addition of all subcomponents” may be provided. In particular, in the configuration rules, it should be strictly recorded how the individual configuration parameters are to be organized formally and as to content. Overall, this measure makes possible, in a particularly simple manner, avoiding costly and distributed checking processes, and instead implementing them centrally and uniquely, and thus consistently.

The comparison of the configuration parameters to the configuration rules can also be carried out using suitable scripts. The use of central configuration rules offers inclusive possibilities for formal specification of the properties and restrictions of the configuration parameters. Consequently, many and detailed tests at a central location are made possible and brought about. In contrast to design approaches described up to now, in which test runs in the respective scripts had to be carried out and programmed separately, a processor or script can now carry out a rules test, a structure test and/or a cross-relationship test can be carried out at a central location. Because of the measure hereof, a transfer is carried out away from program code to rules. By treating the configuration rules as a part of the component interface, far-reaching interface tests are made possible, such as visibility restrictions. Thereby conflicts can be detected early and avoided in response to the exchange of individual components.

An aspect hereof is thus the recognition that it is possible to decisively improve the configuration of a modular system, in particular a microprocessor program, by providing between a user (configurator) and the system an abstract description of the configuration to be implemented in the implementation-independent configuration data file, which is taken as the basis of the configuration. By the use of configuration rules, the configuration parameters can be checked at an early time in the method, which advantageously reduces the effort required for it.

With the aid of the implementation-independent configuration data file, an implementation-dependent configuration data file can automatically be created which is then utilized for configuring the system. However, the system can also be configured without physically creating such data files. Since the configuration parameters are subject to specified configuration rules, a simple and flexible adaptation to specified external parameters can be achieved. The method thus makes it possible to indicate the information describing a configuration in an abstract and therefore particularly easily readable manner. Because of the independence of any implementation details, a particularly great flexibility is also attained, which remains easily comprehensible and manageable, on account of the configuration rules.

Furthermore, there is the advantage of decentralized control. For instance, the properties of a multi-channel measuring system can be stored, not only centrally in a configuration data file assigned to this measuring system, but also centrally, specific as to channel, in a plurality of implementation-independent configuration data files assigned to the respective sensors/channels. These data are then gathered in the container and can be evaluated centrally by scripts.

In addition, for instance, in a process in a mode of division of labor, the configuration rules data files lead to a secure handling of the implementation-independent configuration data files. In particular, in an implementation-independent configuration data file, there may be included configuration elements having different configuration rules data files, whereby the configuration requirements of various modules can be processed in bundled fashion.

In an example embodiment of the method, the configuration rules are used in the automatic setup and/or the automatic updating of the configuration data stored in the configuration data container, and/or in the automatic configuration of the at least one module as a function of the configuration data stored in the configuration data container, and/or in the automatic generation of an implementation-dependent configuration data file as a function of the configuration data stored in the configuration data container. It may also be provided that one should use the configuration rules already during the creation of the implementation-independent configuration data files, as is described below using the example of a configuration data file editor. At the points named, bringing in the configuration rules is particularly easy to carry out. Accordingly, in this connection, a particularly favorable cost-utilization factor is achieved.

It may be provided that the configuration rules are stored in at least one configuration rules data file. In this context, one has the choice of providing a plurality of configuration rules data files, for instance one configuration rules data file for each functional unit or one configuration rules data file for each configuration data file. In one such configuration rules data file, rules are stored for the configuration parameters of the assigned functional unit. Great clarity can be achieved by this. During the configuration method, the individual rules data files are expediently gathered to one central rules data file. It is clear that also only one configuration rules data file can be provided for all configuration parameters to be processed.

In an example embodiment of the method, at least one configuration rule is assigned to a configuration parameter, the configuration rule describing an authorization to process the configuration parameters, a formal property, an existence-determining property or a value-determining property of the configuration parameter. As will be described below, a configuration by dependency information is provided. It is expedient if, in this context, configuration rules with respect to (processing) authorization are provided. One can thereby stipulate, in a simple manner, a hierarchy within the configuration parameters, which describes a mutual modification. In particular it is controllable which configuration parameter can be or is allowed to be described or modified by which other configuration parameters. It might be appropriate here to describe additional properties of configuration parameters by configuration rules, such as
a default value that is used as an alternate value if no value has been given for a parameter; thereby all post-connected processes processing configuration data can rely on the existence of a configuration value;
a specification of valid reference targets, if the assigned configuration parameter represents a list of numbers of configuration settings to be distinguished by identifiers;
an admissible value range (e.g. minimum/maximum value, increment, minimum/maximum text length in the case of textual parameters, fixed, set text type (e.g. Iso date), a text satisfying a certain text pattern or a text identical to a plurality of specified texts);
an instruction for the automatic conversion of a value to another representation;
a conversion formula of an abstract/physical representation of a value to an internal representation and/or vice versa;
a statement as to how a configuration value is, for instance, to be indicated on a display (e.g. format string in a print format);
a connection to another system property, e.g. a variable in a software system or microprocessor program, or a hardware property or resource;
a unit of the configuration value;
a treatment of blank spaces and page breaks in the case of textual information.

In this context, individual, several or all of the rules named, as well as additional ones can be provided for each configuration parameter. It is thereby possible to greatly increase the degree of automation, and to achieve a reliable configuration of the microprocessor program. If a module or a functional unit provides a recording of measured values, for example, it may be described in the associated rule which sensors are to be made available by the hardware, and what type of measuring accuracy is available. The parameter can only be set within these rules.

In example embodiments of the method, at least one item of dependency information, which describes a dependency of at least two configuration data present in the configuration data container, is automatically generated. The at least one implementation-dependent configuration data file is generated as a function of the at least one item of dependency information. Dependency information may describe, for example, whether the modification of one configuration parameter has an effect on another configuration parameter. For instance, if a resource is reserved exclusively for one module, then it is not available to other functional units during the execution of the module/functional unit. With dependency information, it is possible to ascertain which functional units need a specific resource, and therefore cannot run simultaneously. Consequently, dependency information may also be used for resource management. The dependency information is used for forwarding configuration information. During forwarding, a configuration processing entity assigned to a certain component, because of configuration requirements posed to it or because of configuration fine tuning, conducts away configurations of other components by a freely selectable algorithm, and conducts these settings thus ascertained on to these other components. This advantageous measure can be used especially for the automatic configuration of subcomponents.

One may also store the intention of the forwarding in configuration rules, in order to be able to check even before the time of the actual configuration whether, because of this conducting on of configuration data, possibly vicious circles might be created (parameter A configures parameter B which, in turn, configures parameter A). Furthermore, because of the storing in configuration rules, dependencies between the individual components are formally described and are therefore available to other processes that continue processing.

Besides the described moving procedure, the forwarding can also provide a fetching procedure. In a fetching forwarding a specification takes place of a fine tuning of a certain configuration parameter not only from a constant datum but advantageously also from a (possibly more complex and/or conditioned) expression, which includes references to the fine tuning of other parameters. It is also advantageous to provide making a specification of a configuration parameter as a whole (that is, the existence of this specification), in turn a function the setting of other configuration parameters—or possibly of expressions of any complexity made up of such settings. By using configuration rules, an automatic establishment of the forwarding sequence can take place, whereby the detection of possible vicious circles is already made possible at the time of the interface testing.

In an example embodiment of the method, a plurality of implementation-independent configuration data files is created, and each of the implementation-independent configuration data files is assigned to at least one module or functional unit. This allows a particularly simple configuration, because the configuration parameters stored as information in the implementation-independent configuration data files can be found especially easily and modified. For example, it is possible to sort the information determining a configuration, thus, the configuration parameters, according to the functionality influenced by it or hardware. Moreover, a particularly simple adaptation of the implementation-independent configuration data files to newly added functional units is thereby made possible. In the simplest case, a special implementation-independent configuration data file, as well as, for instance, a configuration rules data file are assigned to a newly added functional unit. A plurality of implementation-dependent configuration data files is advantageously generated, and each of the implementation-dependent configuration data files is allocated to at least one functional unit. Such a structuring of the implementation-dependent configuration data files increases the clarity of the implementation-dependent configuration data files generated. If the source code is structured in such a way that one or more functional units are located in different data files, then an implementation-dependent configuration data file can be allocated to each of the data files of the source code. A particularly lucid structuring may also be achieved by in each case assigning one implementation-dependent configuration data file to each implementation-independent configuration data file.

The at least one implementation-dependent configuration data file is preferably generated as a function of at least one property of hardware on which an installation of at least one portion of the configured computer program is to be made possible. For instance, such a hardware property may be the number of processors available or the type and number of sensors connected to the hardware. If such hardware properties are taken into account when generating the implementation-dependent configuration data files, it is then possible to configure the computer program especially precisely. Particularly using dependency information, it is therefore possible, for instance, in this way to automatically create a configuration optimized with regard to execution speed and the use of resources.

In an example embodiment, a documentation is created automatically. The documentation describes the information filed within the at least one implementation-independent configuration data file and/or the at least one implementation-dependent configuration data file and/or the configuration rules and/or the at least one configuration rules data file. Such automatically generated documentation increases the maintainability of the microprocessor program on the one hand, and makes it possible, especially simply, on the other hand to plan and prepare a configuration, and to comprehend a configuration that has been carried out. The automatic generation of the documentation ensures that it conforms with the actual configuration and the configuration rules. If a new configuration of the modular system is to be carried out, then with the aid of such a documentation, it is possible to determine particularly easily which parameter values must or may be modified, and to which rules they are submitted.

In the method, it is expedient, for creating and/or modifying the at least one implementation-independent configuration data file, if a microprocessor program is used which takes into account the configuration rules. Such a computer program or microprocessor program can be designated, for example, as a configuration data file editor, which sufficiently describes the functionality to one skilled in the art. If the configuration rules are used already when the configuration data files are created, the agreement of the configuration parameters with the configuration rules can be ensured right from the beginning. One can then avoid a subsequent reworking. The at least one implementation-independent configuration data file and/or the at least one configuration data rules file are preferably created in an XML-based format. XML (Extensible Markup Language) is a standardized meta language which makes it possible to generate structured languages. If the at least one implementation-independent configuration data file and/or the at least one configuration rules data file is created in an XML-compliant, structured language, then a configuration is facilitated, because such a data file can be read particularly well. Moreover, a data file of this kind can also be read especially well by machine. In particular, there exists a plurality of software tools likewise standardized in part, by which it is possible to edit and process data files created in an XML-based format.

In an example embodiment of the method, it is automatically ascertained as a function of the configuration data, whether a module included in the modular system is required by the modular system, and one configuration of this module is only executed if the module is required by the modular system. This facilitates an especially rapid configuration, because only those modules/functional units are actually configured which are really needed in an execution of the configured system. Furthermore, the configured system thereby takes up as little storage space as possible, when a microprocessor program is involved since, for example, a translation of source code into machine code is only brought about for those functional units which are actually intended to be used.

The method may be used for the configuration of a microprocessor program. However, in principle it can be used for the configuration of any system made up of modules (such as text, data, mechanical components, etc.).

The foregoing is also achieved by a software system of the type indicated at the outset. In this context, the software system, especially a computer program or a microprocessor program, has:
at least one configuration rules data file;
at least one implementation-independent configuration data file;
a configuration data container including configuration data and/or means for creating a configuration data container as a function of information stored in the at least one implementation-independent configuration data file;
device(s) for modifying and/or reading out configuration data from the configuration data container;
device(s) for automatically configuring at least one module as a function of configuration data stored in the configuration data container.

In an example embodiment, the device(s) for automatically configuring at least one module, as a function of configuration data stored in the configuration data container, have:
device(s) for automatically generating at least one implementation-dependent configuration data file as a function of configuration data stored in the configuration data container; and
device(s) for automatically configuring the at least one functional unit as a function of information stored in the implementation-dependent configuration data file.

The software system preferably has device(s) for carrying out the method according, particularly if the software system is executed on a computer, a microprocessor or corresponding processor unit, particularly of the computer unit.

The implementation in the form of a software system is of particular importance, in this instance. In this context, the software system is able to run on a computing device, particularly on a microprocessor, and is suitable for carrying into effect the method. In this case, therefore, an example embodiment of the present invention is implemented by the software system, so that the software system constitutes an example embodiment of the present invention in the same manner as the method for whose execution the software system is suitable.

A further software system and computer program has program code device(s) for the purpose of creating or modifying implementation-independent configuration data files, while taking into account configuration data files (configuration data file editor).

The software system is preferably storable in a memory element (storage medium, data carrier). The memory element may take the form of a random access memory, read only memory or flash memory. The memory element may also be in the form of a digital versatile disk (DVD), compact disk (CD) or hard disk.

A software system product, especially a computer program product or a microprocessor program product, includes program code device(s) which are stored in a memory element, particularly a machine-readable or a computer-readable data carrier. Suitable data carriers are, particularly, diskettes, hard disks, flash memories, EEPROM's, CD ROMS, DVD'S, RAM, ROM and others. Downloading a program via computer networks (Internet, Intranet, etc.) is also possible.

A processor unit, particularly a control device, has a microprocessor and is programmed for carrying out a method.

It is expedient to use a method, a software system, a software system product or a processor unit in the auto industry. It should be understood that the use is not limited to this.

Further advantages and aspects of example embodiments of the present invention will be apparent from the description and the accompanying drawings.

It is understood that the aforementioned features and the features yet to be explained below may be used not only in the combination indicated in each instance, but also in other combinations or by themselves, without departing from the scope of the present invention.

Example embodiments of the present invention are illustrated schematically in the drawings and will be described in detail below, with reference to the drawings.

### BRIEF DESCRIPTION OF THE DRAWINGS

FIG. 1 shows an example embodiment of a software system for carrying out the method according to an example embodiment of the present invention; and

FIG. 2 shows schematic flow chart of the method according to an example embodiment of the present invention.

### DETAILED DESCRIPTION

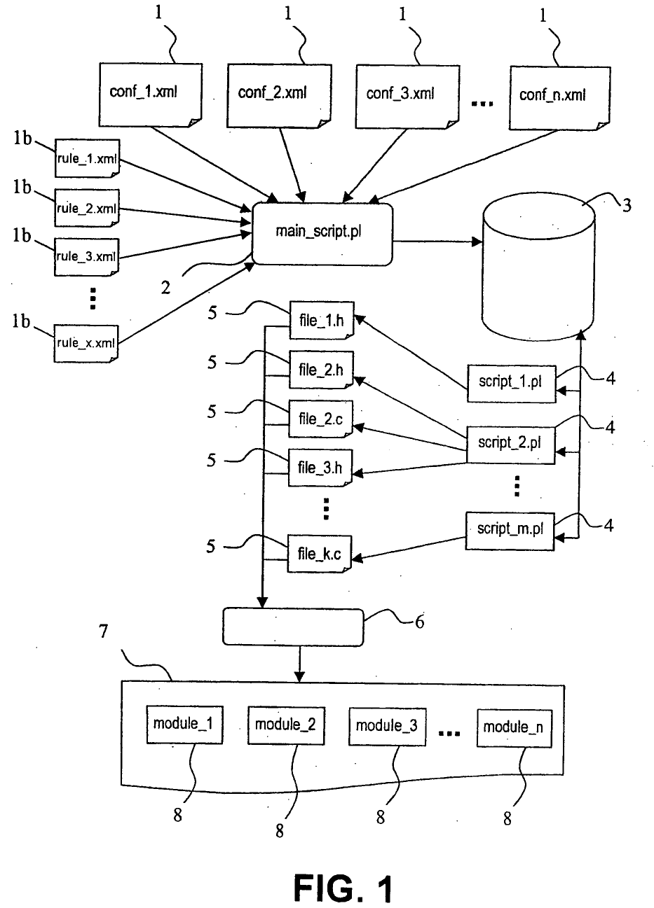

FIG. 1 shows a software system for carrying out the method of example embodiments of the present invention. The software system has a plurality of implementation-independent configuration data files 1. A file name is assigned to each configuration data file 1. The implementation-independent configuration data files shown in FIG. 1, for example, bear data file names conf_{—}1.xml, conf_{—}2.xml, conf_{—}3.xml, . . . to conf_n.xml.

The software system also has a plurality of configuration rules data files 1b. A file name is assigned to each configuration rules data file 1b. The configuration rules data files shown in FIG. 1 bear, for example, data file names rule_{—}1.xml, rule_{—}2.xml, rule_{—}3.xml . . . to rule_x.xml. The data file ending xml points out that implementation-independent configuration data files 1 and the configuration rules data files 1b are present in an xml-based format. A text data file present in an XML-based format makes it possible to structure the text data file according to specifiable rules. Such a structured text data file can be read and processed particularly well manually and by machine.

Implementation-independent configuration data files 1 and configuration rules data files 1b are fed to a script 2. Script 2 is in the form of a so-called Perl script, for example. Perl is an interpreter language whose syntax is based on programming language C, and which uses utility programs made available by the specific operating system.

Using script 2, implementation-independent configuration data files 1 are read, and the information stored therein is extracted and stored in a configuration data container 3. The extraction of the configuration information and configuration parameters takes place while taking into account the configuration rules from configuration rules data files 1b. If the configuration parameters contradict the configuration rules, this can therefore be detected and faulted at an earlier stadium of the configuration. To do this, appropriate instruction texts or error texts may be included, for example, in the configuration rules data files or in script 2, which can be output in response to the infraction of a corresponding rule or rule type. At the same time, possibly existing dependencies with respect to further configuration scripts 4 are also determined and stored (forwarding). The positioning of the configuration rules data files 1b within the software system may be seen, for instance. Configuration rules data files 1b may be assigned, for instance, to scripts 4, in another specific embodiment of the software system.

Additional configuration scripts 4 are also Perl scripts, for example. It is equally conceivable that one or more of further configuration scripts 4 is an executable microprocessor program (machine code), or exists in another script language, e.g., AWK.

Implementation-dependent configuration data files are denoted by reference numeral 5. For example, implementation-dependent configuration data files 5 are coded in the programming language in which the source code to be configured is also programmed. Such implementation-dependent configuration data files are able to be processed by a compiler 6.

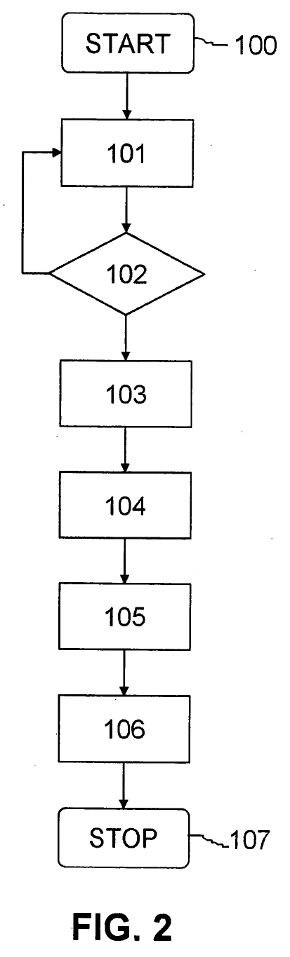

Reference numeral 7 denotes a microprocessor program having a plurality of functional units 8. The functioning method of the software system according to example embodiments of the present invention is described with reference to the flow chart shown in FIG. 2.

The flow chart shown in FIG. 2, of a method, according to example embodiments of the present invention, for configuring a microprocessor program starts at step 100. In a step 101, implementation-independent configuration data files 1 are created or modified. Implementation-independent configuration data files 1 have the special distinction that, using the information stored there, it is possible to abstractly describe concrete configuration values or configuration parameters. For instance, concrete configuration values are able to define the measuring range of a sensor module for measuring an electric voltage. It is possible, for instance, to indicate a measuring range abstractly using the values 3-5 volts. However, the implementation-dependent values of the measuring range to be generated therefrom, in the manner functional unit 8 to be configured expects it, may lie between 10,000 and 20,000, for example. In this case, a functional unit 8, of the microprocessor program, that controls the sensor module, would have to be configured using the concrete configuration values 10,000 and 20,000, for instance, to permit a measurement in a measuring range of 3-5 volts.

In addition, configuration rules data files 1b (rule_{—}1.xml to rule_x.xml in FIG. 1) are also available for the method. Usually, configuration rules data files 1b are not created or modified in response to each performance of the method. Configuration rules data files 1b describe the formal and content properties of the configuration parameters.

Implementation-independent configuration data files 1 and configuration rules data files 1b created or modified in step 101 are created, for example, in an XML-based format. Such a format makes it particularly easy to achieve a lucid structuring of implementation-independent configuration data files 1 and configuration rules data files 1b. This increases the readability of implementation-independent configuration data files 1 and configuration rules data files 1b, and simplifies the modification of implementation-independent configuration data files 1, e.g., because configuration data to be modified can be quickly found. It is possible to provide only one single implementation-independent configuration data file or configuration rules data file, even for a particularly large microprocessor program requiring a multitude of configuration data for its configuration. In this context, the information stored in implementation-independent configuration data file 1 and the configuration rules stored in configuration rules data file 1b are able to be structured using suitable XML structures. However, it is especially advantageous to provide a plurality of implementation-independent configuration data files and configuration rules data files. For instance, each of these implementation-independent configuration data files 1 and configuration rules data files 1b may be assigned to one or more functional units 8. It is thereby possible to create or modify the implementation-independent configuration data files and configuration rules data files in a particularly clear manner. In addition, reusability of individual implementation-independent configuration data files and configuration rules data files is thereby increased. This is especially advantageous for projects in which individual functional units 8 of the source code are also to be reused.

In a step 102 the instructions listed in script 2 are processed. Script 2 causes independent configuration data flies 1 and configuration rules data files 1b to be read in. If implementation-independent configuration data files 1 and/or configuration rules data files 1b are based on a structured format, e.g., an XML-based format, then a syntactic and/or semantic analysis of the contents of implementation-independent configuration data files 1 and/or configuration rules data files 1b may be carried out particularly well using script 2. (Data file) errors in the detail of the configuration data can be detected thereby (missing symbols, too many symbols, wrong symbols, etc.). Preferably, the XML-based format of implementation-independent configuration data files 1 and configuration rules data files 1b has a hierarchical structure that is advantageously oriented to the structure of functional units 8 themselves, their dependencies and/or their thematic closeness. Errors in the setup of this hierarchical structure, and therefore also in the setup of the source code itself may be recognized using script 2.

Errors found are advantageously handled in step 102. This may be accomplished, for example, by the output of error information. It is equally possible to use stochastic methods to remove errors.

The configuration parameters are also checked in step 102, with the aid of the configuration rules. In this context what is particularly checked is whether the configuration parameters correspond formally and as to content to the associated configuration rules. If this is not the case, the method branches back to step 101, in which a change is made in implementation-independent configuration data files 1 with the aim of eliminating errors. If no errors are detected in step 102, the system branches to a step 103, in which configuration data container 3 is set up or updated.

In step 103, script 2 extracts the configuration data present in implementation-independent configuration data files 1 and stores them in configuration data container 3. Configuration data container 3 may be in the form of a database, for example, in this instance. It is likewise possible to implement configuration data container 3 as a data structure, provided in a storage area, within the software system of the present invention, in so doing, it being ensured that script 2 has writing and reading access to the configuration data stored in configuration data container 3.

In a step 104, dependencies are ascertained. For example, one such dependency may describe which functional units 8 of the microprocessor program must actually be processed in the case of the present configuration. With the aid of these dependencies, it is possible to decide whether, in one of the following steps, it is necessary to generate an implementation-dependent configuration data file for a specific functional unit 8 at all. Dependencies may further describe which concrete configuration data are a function of which abstract configuration data. Thus, it is possible that the change of an abstract configuration datum in an implementation-independent configuration data file gives rise to a change in a plurality of concrete configuration data.

Dependencies may also arise if further scripts 4 on their part modify configuration container 3. Thus, the correct calling sequence (activation sequence) of scripts 4 must be ascertained and stored. Dependencies may also describe relationships between one or more hardware components and individual configuration data. This makes it possible to recognize, for instance, whether a configuration provided is actually executable on specific hardware.

In step 105, implementation-dependent configuration data files 5 are generated. To that end, first of all the configuration data stored in configuration data container 3 are retrieved with the aid of a script 4 or a plurality of scripts 4. In the present exemplary embodiment, scripts 4 are in the form of Perl scripts. Abstract configuration data, stored in particular in configuration data container 3, are converted by scripts 4 into concrete configuration data, which are then stored in implementation-dependent configuration data files 5. In so doing, preferably the dependencies ascertained in step 104 are used as well.

The implementation-dependent configuration data files 5 generated in step 105 may be, for example, header data files (file_{—}1.h, file_{—}2.h, file_{—}3.h in FIG. 1). In the same way, generated implementation-dependent configuration data files 5 may also contain source code (file_{—}2.c, file_k.c in FIG. 1). Typically, the concrete configuration data generated by scripts 4 from the abstract configuration data are implemented by value assignments for variables and/or function parameters, and as instructions in a programming language. In this context, the programming language corresponds to the programming language in which functional units 8 of microprocessor program 7 are coded. For example, if functional units 8 of microprocessor program 7 are coded in programming language C++, then the concrete configuration data may be implemented by so-called define instructions, for instance, or by the definition of constant variables. Depending on the configuration data stored in configuration data container 3, with the aid of scripts 4, it is also possible to generate functions which assume complex tasks—such as the initialization of hardware components, or checking for the presence of individual software components or hardware components—and are themselves implemented as source code in a higher programming language. This source code may then be stored in one or more implementation-dependent configuration data files (file_{—}2.c, file_k.c in FIG. 1). For that purpose, for example, a script 4 may contain a so-called template, made up, for instance, of instructions in C++, which are updated as a function of the configuration data stored in configuration data container 3, and are stored in an implementation-dependent configuration data file 5.

In step 106, functional units 8 of microprocessor program 7 are updated. For example, this may be accomplished by the automatic call-up of a compiler 6 which translates functional units 8, existing in a source code, into a machine code. To that end, compiler 6 reads in implementation-dependent configuration data files 5 and controls the generation of the machine code as a function of the concrete configuration data stored in implementation-dependent configuration data files 5. It is also conceivable that one or more functional units 8 already exist in machine code. In this case, the compiler may, for instance, translate the source code (file_{—}2.c, file_k.c in FIG. 1), generated by scripts 4, into machine code, taking into account the header data files (file_{—}1.h, file_{—}2.h, file_{—}3.h), and link the machine code thus translated to the machine code representing functional units 8 with the aid of a so-called linker assigned to compiler 6.

The method ends in step 107. In this step, microprocessor program 7 is configured in such a way that the concrete configuration data, stored in the implementation-independent configuration data files, are taken into account in the machine code generated.

It is possible for script 2 and/or scripts 4 to be written in another script language, or to be developed as executable programs. It is also possible to use the configuration rules only in connection with scripts 4.

The execution steps shown in FIG. 2 may, of course, vary, and the processing sequence may be able to be partially modified. In particular, the method may also start out from one or more implementation-independent configuration data files; have one or more scripts 2 that, for instance, are carried out consecutively; have one or more scripts 4, each generating one or more implementation-dependent configuration data files 5; and of course, microprocessor program 7 may have one or more functional units 8. Using the method of the present invention, it is possible, in particular, to recognize whether one or more of functional units 8 actually come to be used in the configuration specified by the implementation-independent configuration data files. If this is not the case, it can be recognized by a software tool (not shown), assigned to configuration data container 3. This makes it possible that such a functional unit 8 is not configured, and with the aid of implementation-dependent configuration data files 5, compiler 6 is induced not to import functional unit 8 into the machine code to be generated. The method may thereby be carried out particularly rapidly. The machine code generated by a microprocessor program, which was configured using the method, may, in this instance, be especially compact and consequently may be able to save memory space.

There is the possibility that script 2 itself is already brings about the generation of one or a plurality of implementation-dependent configuration data files 5. The method may thereby be carried out particularly rapidly. For example, this may be advantageous for abstract configuration data that have no dependencies and differ from the concrete configuration data.

1-19. (canceled)

20. A method for configuring a system including at least one module, comprising:
at least one of (a) creating at least one implementation-independent configuration data file and (b) modifying information stored in the at least one implementation-independent configuration data file;
at least one of (a) automatically setting up and (b) automatically updating configuration data, stored in a configuration data container, as a function of the information stored in the at least one implementation-independent configuration data file;
automatically configuring at least one module as a function of the configuration data stored in the configuration data container; and
using configuration rules.

21. The method according to claim 20, wherein the automatically configuring step includes:
automatically generating at least one implementation-dependent configuration data file as a function of the configuration data stored in the configuration data container; and
automatically configuring the at least one module as a function of information stored in the at least one implementation-dependent configuration data file.

22. The method according to claim 20, wherein the configuration rules are used in the at least one of: (i) the at least one of (a) the automatically setting up and (b) the automatically updating of the configuration data stored in a configuration data container (3); (ii) the automatically configuring the at least one module as a function of the configuration data stored in the configuration data container; and (iii) automatically generating at least one implementation-dependent configuration data file as a function of the configuration data stored in the configuration data container.

23. The method according to claim 20, wherein the configuration rules are stored in at least one configuration rules data file.

24. The method according to claim 20, wherein at least one configuration rule is assigned to at least one of (a) a configuration parameter, (b) a configuration rule describing an authorization for processing the configuration parameter, (c) a formal property, (d) an existence-determining property and (e) a value-determining property of the configuration parameter.

25. The method according to claim 20, wherein at least one item of dependency information is generated automatically, which describes a dependency of at least two configuration data present in the configuration data container; and the at least one implementation-dependent configuration data file is generated as a function of the at least one item of dependency information.

26. The method according to claim 20, wherein the system includes a modular system having a plurality of modules, and wherein a plurality of implementation-independent configuration data files is created, and each of the implementation-independent configuration data files is assigned to at least one module.

27. The method according to claim 21, wherein the at least one implementation-dependent configuration data file is generated as a function of at least one property of hardware on which an installation of at least one portion of a configured modular system as a microprocessor program is to be made possible.

28. The method according to claim 21, wherein a documentation is created automatically and the documentation describes the information filed within at least one of (a) the at least one implementation-independent configuration data file, (b) the at least one implementation-dependent configuration data file, (c) the configuration rules and (d) at least one configuration rules data file.

29. The method according to claim 20, wherein a microprocessor program, which takes into account the configuration rules, is used for at least one of (a) creating and (b) modifying at least one implementation-independent configuration data file.

30. The method according to claim 20, wherein at least one of (a) the at least one implementation-independent configuration data file and (b) at least one configuration rules data file are created in an XML-based format.

31. The method according to claim 20, wherein it is automatically ascertained as a function of the configuration data, whether a module included in a modular system is required by the modular system, and one configuration of this module is only executed if the module is required by the modular system.

32. The method according to claim 20, wherein the module includes a microprocessor program.

33. A system for configuring at least one system including at least one module, comprising:
at least one configuration rules data file;
at least one implementation-independent configuration data file;
at least one of (a) a configuration data container including configuration data and (b) a device configured to create a configuration data container as a function of information stored in the at least one implementation-independent configuration data file;
a device configured to at least one of (a) modify and (b) read out configuration data from the configuration data container; and
a device configured to automatically configure the at least one module as a function of the configuration data stored in the configuration data container.

34. The system according to claim 33, wherein the device configured to automatically configure at least one module as a function of configuration data stored in the configuration data container includes:
a device configured to automatically generate at least one implementation-dependent configuration data file as a function of configuration data stored in the configuration data container; and
a device configured to automatically configure the at least one module as a function of information stored in the implementation-dependent configuration data file.

35. The system according to claim 33, further comprising a device configured to perform a method according to claim 20.

36. The system according to claim 33, further comprising a device configured to at least one of (a) create and (b) modify implementation-independent configuration data files, while taking into account the configuration rules.

37. A computer-readable medium containing a computer program which when executed by a processor performs a method for configuring a system including at least one module including:
at least one of (a) creating at least one implementation-independent configuration data file and (b) modifying information stored in the at least one implementation-independent configuration data file;
at least one of (a) automatically setting up and (b) automatically updating configuration data, stored in a configuration data container, as a function of the information stored in the at least one implementation-independent configuration data file;
automatically configuring at least one module as a function of the configuration data stored in the configuration data container; and
using configuration rules.
